(19) United States
(12) Patent Application Publication
(10) Pub. No.: US 2008/0003076 A1
(43) Pub. Date: Jan. 3, 2008

(54) Multipurpose Lading Tie Anchor System For Securing Cargo

(75) Inventor: John Brewster, Homewood, IL (US)

Correspondence Address: BARNES & THORNBURG LLP, P.O. BOX 2786, CHICAGO, IL, 60690-2786, US

(73) Assignee: HOLLAND LP, Crete, IL (US)

(21) Appl. No.: 10/598,433

(22) PCT Filed: Mar. 3, 2005
(86) PCT No.: PCT/US05/07355

§ 371 Date: Aug. 30, 2006

Related U.S. Application Data
(60) Provisional application No. 60/550,788, filed on Mar. 5, 2004.

(51) Int. Cl. B60P 7/08

(52) U.S. Cl. 410/117

(57) ABSTRACT

An anchor (10) with a shaped aperture (15) that receives various and multiple types of tie straps (25)(32)(33) and strap hardware end comprised of straps of woven webbing with or without a hook or pin end, or straps of the one-time useable steel banding type. The tie strap (25)(32)(33) being held in place by the appropriate anchor provision and the said anchor being contained within a pocket in the wall (21) or floor (20) of railway box or flat car (84). Various industry lading tie straps, bands, strap end pin or strap end hooks already in use are allowed to be connected to the shaped aperture anchor. An appropriate ratchet inherent to the specific type of tie strap being used is operated to remove any remaining slack in the lading ties (25)(32)(33) and then apply the desired tension thereon to secure the lading to the railway car.

### CROSS-REFERENCE TO RELATED APPLICATION

This application claims the benefit of U.S. Provisional Patent Application Ser. No. 60/550,788 filed Mar. 5, 2004.

### BACKGROUND OF THE INVENTION

Loads on railway cars need to be restrained from shifting under the various loads imposed by draft, buff, and rocking of the car. For particular types of loads, such as large rolls or coils of sheet material, or palletized loads, tensioning mechanisms using straps and anchors are advantageous.

To avoid the limitations with present practices of prior art the invention relates generally to the improvement in lading tie anchor systems for railway cars. Prior art is specific to a particular type of strap, hook, pin or anchor fitting and is limited to its own inherent arrangement. The invention combines several distinct elements into an improved cargo lading tie anchor system so as to offer the user more versatility in securing cargo.

This novel multipurpose anchor has multiple provisions and adapted to receive various different types of straps and cargo lading tie hardware that correspond to their particular attachment features.

The invention also provides a lading tie anchor system and method of using the same which can use various lading tie straps, bands, strap end pin or strap end hooks already in use and practice with various railway cars.

The anchor fitting is mountable in a wall, deck or support of a vehicle so that the fitting can be adapted to different load conditions including a different mix of lading.

### DESCRIPTION OF RELATED ART

U.S. Pat. No. 6,422,794 teaches a cargo snugger strap and hook mechanism with an anchor with a “L” shaped aperture, where said system is dependant upon cargo straps and hook mechanism tailored to fit the specific “L” shaped aperture anchor. The disclosure in this patent is incorporated by reference in the instant application as if fully set forth herein.

U.S. Pat. No. 6,402,446 teaches a lading tie anchor system with a strap and a specific rigid hook body that respectively is retained and dependant upon a specifically shaped tie anchor aperture. The disclosure in this patent is incorporated by reference in the instant application as if fully set forth herein.

Application Publication No. 2003/0133767A1 published Jul. 17, 2003, shows two apertures, one for a pin and one for a plain woven strap. The unique capability of multipurpose anchor 10 allows enhanced usability for the railway car 34. Different arrangements, size and shaped lading 22 call for particular lading tie anchor system scenarios. The applicant's invention is intended to offer multiple lading tie hardware usage options so as to result in the railway car 84 being more versatile than what is disclosed within the prior art that has been previously discussed.

The forgoing prior art teaches certain parameters for lading tie anchor and lading tie strap systems and uses specific solutions to meet the needs. The instant invention departs from the limited functionality in its use of the anchors being specific to a limited selection of tie straps. Additionally, the prior art typically uses specific hardware that is dedicated for its specific use and is not versatile in its nature. The instant invention utilizes simple, yet offers an anchor with provisions to accept multiple strap configurations and not limited to the specific “L” shaped or bar shaped aperture anchor which offers a real advantage for the user so the user is not limited to usage of a limited strap hardware provision.

### BRIEF DESCRIPTION OF THE DRAWINGS

FIG. 1 is a largely schematic perspective view of support surfaces to which the indicated anchors and lading tie straps have been applied, and several cargo pallet loads to be supported thereon, which support surface may be, for instance, the wall or deck of a railway box car.

FIG. 2 is a diagrammatic perspective view showing a multipurpose anchor disposed to receive the various types of conventional lading tie straps and/or connecting hardware.

FIG. 3 is a front elevational view of the multipurpose anchor disposed to receive the various types of conventional lading tie straps and/or connecting hardware.

FIG. 4 is a side elevational view of the multipurpose anchor.

FIG. 5 is a back elevational view of the multipurpose anchor.

FIG. 6 is a horizontal view of the multipurpose anchor.

FIG. 7 is a sectional view taken on line 35 of FIG. 3.

FIG. 8 is a sectional view taken on line 34 of FIG. 3.

FIG. 9 is a horizontal view of the multipurpose anchor showing that the back surfaces have been and are allowed to be tailored to fit and interface the railway car as the user desires.

FIG. 10 is a side elevational view of the multipurpose anchor showing that the surfaces have been and are allowed to be tailored to fit and interface the railway car as the user desires.

FIG. 11 is a front elevational view of the multipurpose anchor showing that the front surfaces have been and are allowed to be tailored to rearrange the features so as to receive the various types of conventional lading tie straps and/or connecting hardware in the railway car as the user desires.

FIG. 12 is a side elevational view of the multipurpose anchor showing that the surfaces have been and are allowed to be tailored to fit and interface the railway car as the user desires.

FIG. 13 is a sectional view taken on line 36 of FIG. 11.

FIG. 14 is a back elevational view of the multipurpose anchor showing that the back surfaces have been and are allowed to be tailored to rearrange the features so as to receive the various types of conventional lading tie straps and/or connecting hardware and to fit and interface the railway car as the user desires.

FIG. 15 is a front elevational view of the multipurpose anchor showing an another example that the front surfaces have been and are allowed to be tailored to rearrange the features so as to receive the various types of conventional lading tie straps and/or connecting hardware in the railway car as the user desires.

FIG. 16 is a front elevational view of the strap and anchor during the step of aligning the pin with the multipurpose anchor.

FIG. 17 is a front elevational view of the strap properly seated within the multipurpose anchor.

FIG. 18 is a sectional view taken on line 37 of FIG. 17.

FIG. 19 is a back elevational view of the strap properly seated within the multipurpose anchor.

FIG. 20 is a sectional view taken on line 35 of FIG. 3 illustrating the arrangement of steel banding or a woven strap in relation with the lading tie receiving provision of the multipurpose anchor.

FIG. 21 is a sectional view taken on line 35 of FIG. 3 illustrating the arrangement of a lading tie strap with a hook type clip in relation with the lading tie receiving provision of the multipurpose anchor.

### DETAILED DESCRIPTION OF THE PREFERRED EMBODIMENT

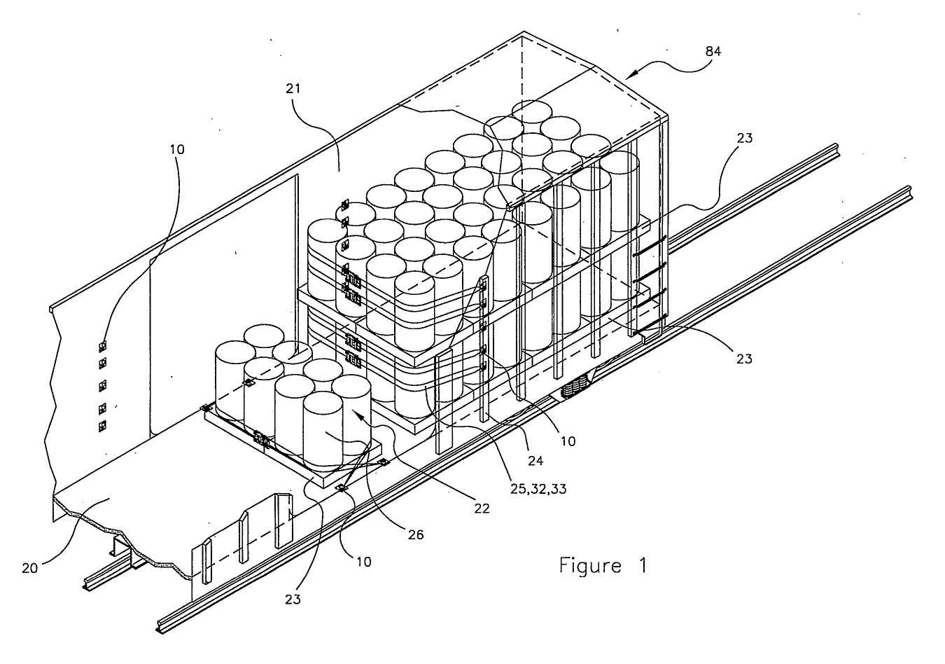

Referring now to FIG. 1, there is illustrated in somewhat of a diagrammatic manner a support 20 upon which a cargo pallet 23 with lading 22 is to be secured by Applicant's improved multipurpose anchor 10 by way of use of a typical industry cargo lading tie strap 25, 32 or 33 that, in this regard, are arranged in accordance with the principles of the present invention herein disclosed. The wall support 21 upon which a cargo lading tie strap 25, 32 or 33 is to be secured by Applicant's improved multipurpose anchor 10 that, in this regard, are arranged in accordance with the principles of the present invention herein disclosed. The support 20 may, for instance, be a deck or floor of a railway flat car or other rail transport vehicle 84, or support 20 may be another type of vehicle to which the device 10 is applied in multiples for the usual application thereof to lading 22 with or without cargo pallets 23. The wall support 21 may, for instance, be a wall or bulkhead of a railway boxcar or other rail transport vehicle 84, or wall support 21 may be another type of vehicle to which the device 10 is applied in multiples for the usual application thereof to lading 22 with or without cargo pallets 23.

The principles of the present invention are applicable to securing various types of lading 22 to various types of supports 20, 21 and 24. In the FIG. 1, illustrated embodiment of the invention, the cargo lading 22 is of a cylindrical container 26 configuration that is involved in containing various types of commodities within. Illustrated are four containers 26 arranged upon a pallet 23, but containers 26 may be of any number or configuration as deemed desired by the user and industry practice. The cargo lading 22 need not be cylindrical in form and may be of any size and shape deemed desired by the user and industry practice. FIG. 1 illustrates various pallets 23 arranged as desired by the user which may include stacking upon support 20. It is to be noted that pallets 23 are not necessary for securing lading 22 by Applicant's improved multipurpose anchor 10 by way of use of a typical industry cargo lading tie straps 25, 32 or 33 that, in this regard, in accordance with the principles of the present invention herein disclosed. Lading 22 and lading tie straps 25, 32 or 33 may be of the type specified by the standards of the Association of American Railroads. The interface between multipurpose anchor 10 and support 20 and/or wall support 21 is tailorable so as to assure proper securement of lading 22, modifications thereto will be apparent to those skilled in the art. In FIG. 1, multipurpose anchor 10 is mountable to a side wall stake post 24 illustrating one example of said proper support. In accordance with the present invention, the multipurpose anchors 10 are intended to be mounted to achieve securement of the respective lading 22 as hereinafter disclosed.

Applicant's improved multipurpose anchor 10 is shown in various locations of support 20 and/or wall support 21 in FIG. 1. The number and location of said anchor 10 is tailorable to provide the desired securement options desired by the user and thereto will be apparent to those skilled in the art.

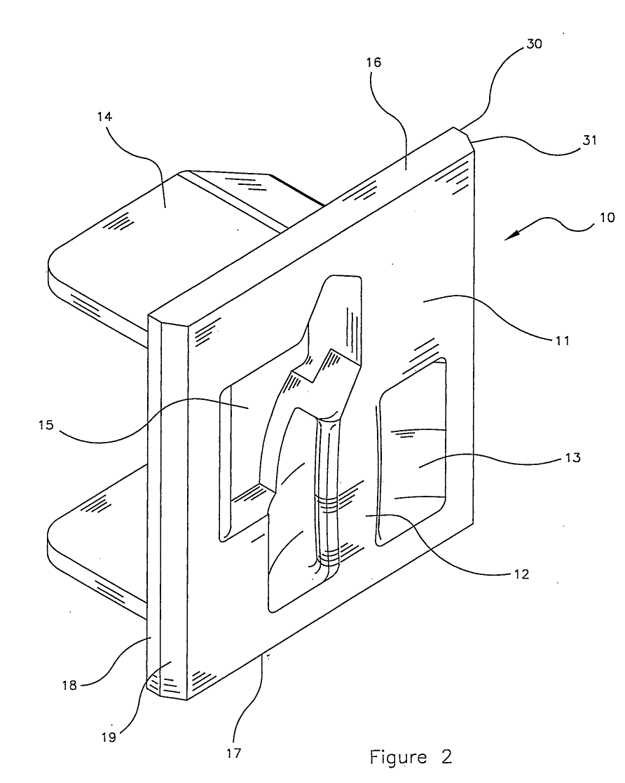

The multipurpose anchor 10 of the present invention is illustrated in detail in FIGS. 2 through 21, which will be described in detail hereinafter.

The improved multipurpose anchor 10 is comprised of front surface 11, a lading tie receiving section 12, a lading tie clearance cavity 13, back contoured surface 14 and a lading tie aperture 15. A perspective view is shown in FIG. 2. The multipurpose anchor 10 has side edges 16, 17, 18, 19, 30 and 31 which extend outwardly from the multipurpose anchor face 11 which interface with a vehicle support 20 or wall support 21 and is tailorable to provide the desired attachment options desired by the user and thereto will be apparent to those skilled in the art. The actual size and shape of the side edges are allowed to be varied as desired by the user and is not dependant upon the function of the applicant's invention. The back contoured surface 14 is tailorable to provide the desired attachment options and car clearances desired by the user and thereto will be apparent to those skilled in the art.

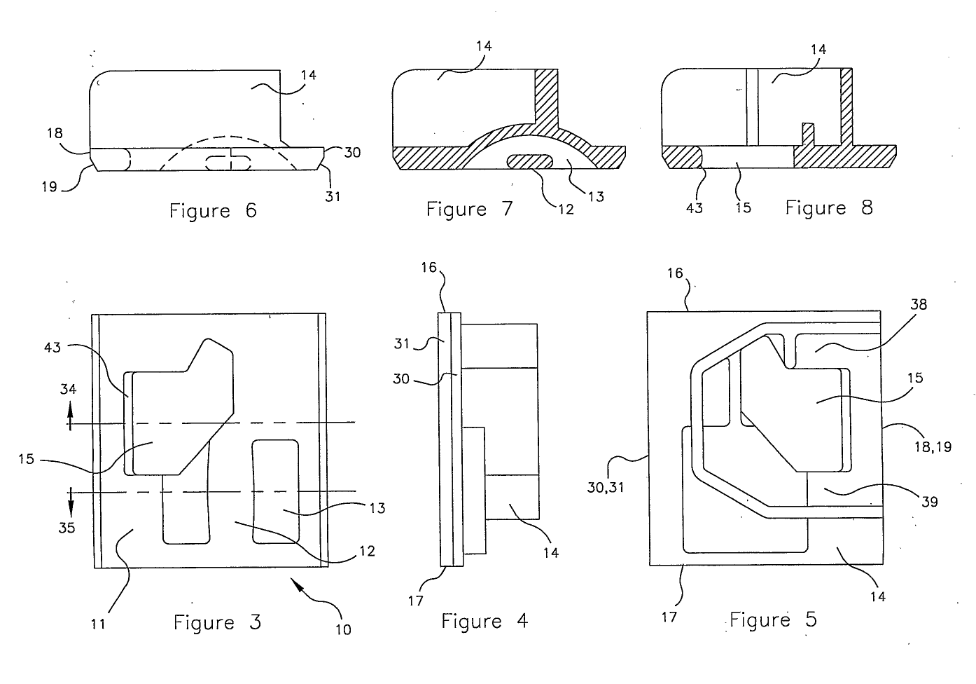

The illustrations in FIGS. 3, 11 and 15 show a typical front view of three alternative different front arrangements of the multipurpose anchor. The views show the surface 11 of said multipurpose anchor 10 that is typically exposed and ready for acceptance of the various cargo lading tie straps 25, 32 or 33. FIG. 3 illustrates a scenario of aperture 15 and lading tie receiving section 12 in which they are offset partially horizontally and vertically. Lines 34 and 35 represent their relative horizontal centers. FIG. 11 shows an embodiment in which aperture 15 and lading tie receiving section 12 are both aligned along line 36. FIG. 15 illustrates an embodiment where aperture 15 and lading tie receiving section 12 are vertically aligned about line 40. Each of these embodiments can receive a variety of load securement connectors such as pins, hooks, clips, woven straps or metal binding. The embodiments of a pin end tie strap 25, steel or woven synthetic loop-end tie strap 32 or hook end tie strap 33 are all usable with the multi-purpose anchor.

A side elevational view of multipurpose anchor 10 is shown in FIG. 4. Typically all the surfaces shown would be hidden from view of the user, as the anchor is imbedded in a wall, or floor, and are not all necessary for the function of the securing of the preferred lading tie straps 25, 32 or 33. FIGS. 10 and 12 illustrate respective side views of alternate front surface 11 view of FIG. 11 where different front arrangements of said multipurpose anchor 10 is allowed.

A back elevational view of multipurpose anchor 10 is shown in FIG. 5. As with FIG. 4, the surfaces would be hidden from view. Surfaces 38 and 39 are the respected areas where pin ends 27a and 27b of lading tie strap 25 rest on during securement of lading 22. All other exterior surfaces in FIG. 5 are tailorable so as to interface with railway car 34 support surfaces 20, 21 and/or 24 as desired.

An alternate back elevational view of anchor 10 is shown in FIG. 14 which is the back of the embodiment of FIG. 11. As with the other views, the interior surfaces shown would be hidden. Surfaces 41 and 42 are the respected areas where pin ends 27a and 27b of lading tie strap 25 rest on during securement of lading 22. All other viewable surfaces in FIG. 14 are tailorable so as to interface with railway car 34 support surfaces 20, 21 and/or 24 as desired. Referring to FIGS. 5 and 14 it may also be recognized that the nonfunctional areas in aperture 15 are tailor able as desired.

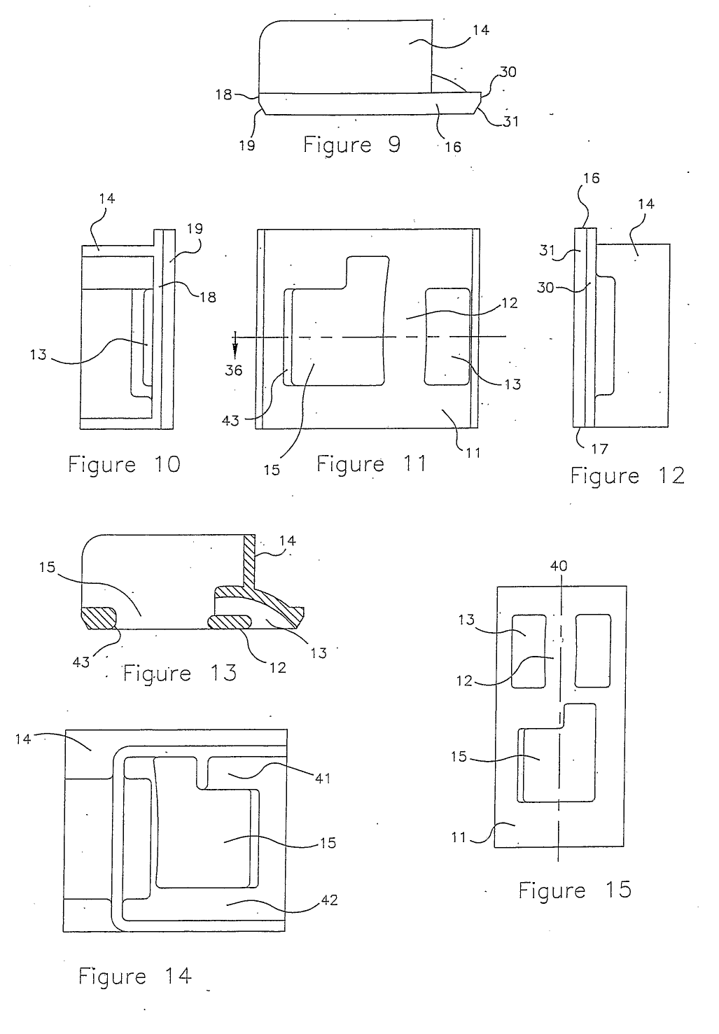

FIGS. 6 and 9 are horizontal views of two different arrangements of anchor 10 relative to the front surface 11 view of FIGS. 3 and 11 where different front arrangements of anchor 10 is allowed. Typically the surfaces shown would be hidden, and are not necessary for the function of the securing of the desired lading tie straps 25, 32 or 33.

FIG. 7 is a sectional view taken on line 35 of FIG. 3 which more clearly illustrates a horizontal view of clearance cavity 13. Clearance cavity 13 is to offer a path for the proper securement of lading tie straps 32 or 33.

FIG. 13 is a sectional view taken on line 36 of FIG. 11 which more clearly illustrates a horizontal view of an alternate clearance cavity 13 and aperture 15. Alternate clearance cavity 13 and aperture 15 is tailorable but is to offer a path for the proper securement of lading tie straps 25, 32 or 33.

FIG. 8 is a sectional view taken on line 34 of FIG. 3 showing a horizontal view of aperture 15 opening. Aperture 15 provides a path for the proper securement of lading tie strap 25.

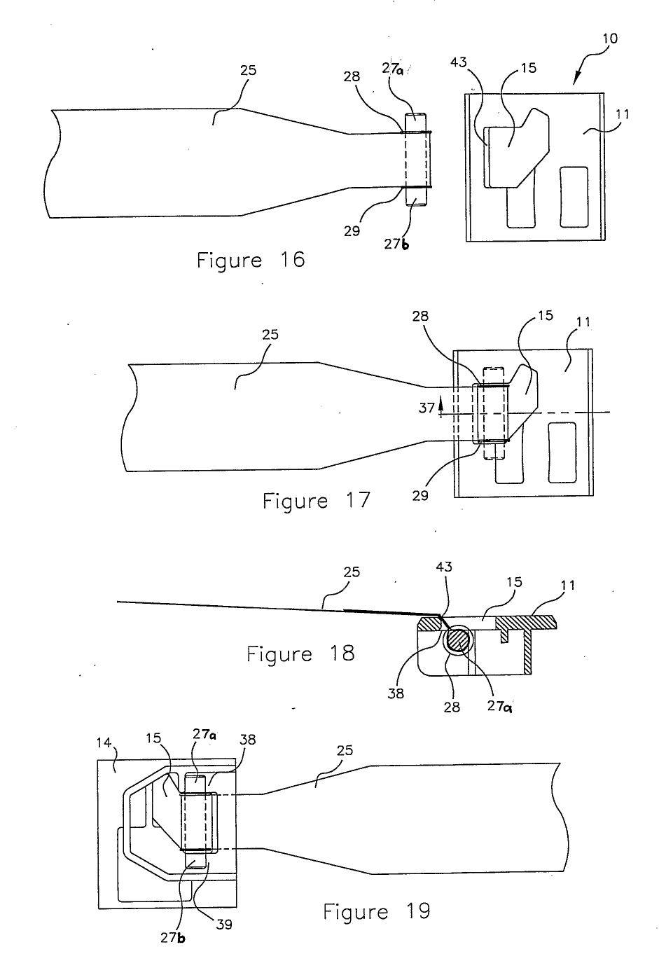

FIG. 16 illustrates a plan view of lading tie strap 25 and multipurpose anchor 10 during the step of aligning pin ends 27a and 27b into aperture 15. Aperture 15 opening in said multipurpose anchor 10 is to be shaped appropriately so as to allow proper insertion of pin ends 27a and 27b.

FIG. 17 is a plan view of lading tie strap 25 secured in said multipurpose anchor 10. Pin collars 28 and 29 aid in keeping lading tie strap 25 properly aligned within aperture 15 of said multipurpose anchor 10.

FIG. 18 is a sectional view taken on line 37 of FIG. 17 illustrating pin end 27a and pin collar 28 seated on area 38 and aperture 15 of anchor 10. The flexible part of lading tie strap 25 is shown seated and supported against shoulder 43 of said multipurpose anchor 10.

FIG. 19 is a back elevational view of said multipurpose anchor 10 with lading tie strap 25 properly secured. Pin ends 27a and 27b are respectively shown seated onto surfaces 38 and 39 of said multipurpose anchor 10.

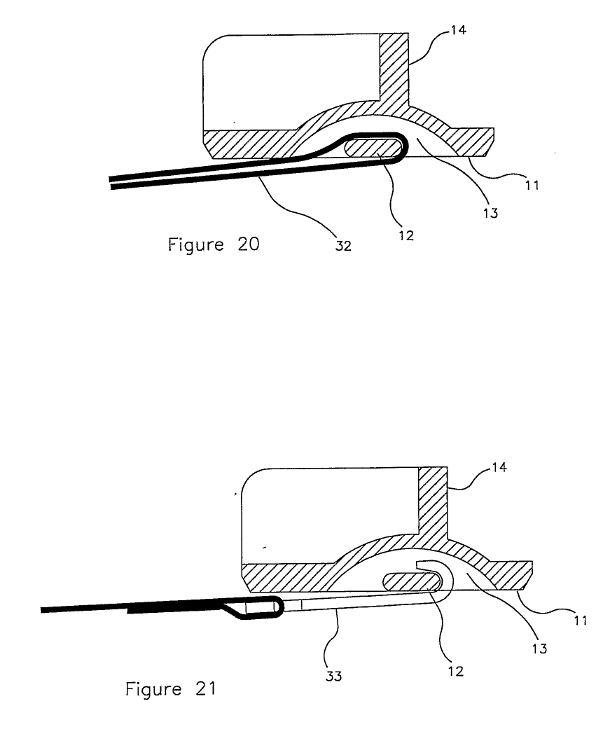

FIG. 20 is a sectional view taken on line 35 of FIG. 3 illustrating a lading tie band 32 seated around lading tie receiving section 12 appropriately. Loop end lading tie band 32 represents industry standard steel banding. Alternatively, other conformable and/or flexible securement material such as a woven synthetic fiber-strap could be used. Clearance cavity 13 and receiving section 12 is allowed to be tailored so as to allow the various types of industry lading tie strap or band 32 to be utilized with said multipurpose anchor 10. Notably, the proportions illustrated for cavity 13 would receive a fiber-strap and actually exceed the height needed for a steel band.

FIG. 21 is a sectional view taken on line 35 of FIG. 3 illustrating a lading tie strap with a hook-type clip 33 seated around lading tie receiving section 12. Hook 33 is an industry flexible strap with one or both ends having typically metallic hook-type clips. Clearance cavity 13 and receiving section 12 is allowed to be tailored so as to allow the various types of industry lading tie strap clips 33 to be utilized with anchor 10.

Anchor 10 has the capability to accept various different types of cargo lading straps 25, 32 and 33 unlike the prior art.

The applicant's multipurpose anchor 10 is different from U.S. Pat. No. 6,422,794 in that it is not limited to receiving only the lading tie strap 25 with pin ends 27a and 27b disclosed. The applicant's invention of said multipurpose anchor 10 allows the use of the prior art strap 25 and has an additional enhancement feature 12 which allows other types of lading tie straps 32 and/or 33 to be used by the user.

The applicant's multipurpose anchor 10 is different from U.S. Pat. No. 6,402,446 discussed above in that it is not limited to receiving only the lading tie strap 33 with the rigid hook body disclosed. The applicant's invention of said multipurpose anchor 10 allows the use of the prior art strap 33 and has an additional enhancement feature 15 which allows lading tie strap 25 to be used by the user.

Although the invention is described with respect to a preferred embodiment, modifications thereto will be apparent to those skilled in the art. Therefore, the scope of the invention is to be determined by reference to such claims as may be submitted.

I claim:

1. A multipurpose anchor system for securing loads in a transport vehicle comprising:
an anchor fitting attached to a vehicle having
a front surface with a clearance cavity disposed about a receiving section adapted to receive a first securement connector,
an aperture within said front surface adapted to receive a second securement connector,
a back contoured surface, adapted to catch said second securement connector being received by said aperture; and
a flexible tensile member having a first end, one of said first and second securement connectors being affixed to said tensile member at said first and end in cooperation with said anchor fitting.

2. The anchor system of claim 1 wherein said first securement connector being selected from the group consisting of a hook, a clip, a pin, a woven strap, and a metal binding.

3. The anchor system of claim 1 wherein said second securement connector is comprised of a pin.

4. The anchor system of claim 3 wherein said pin is comprised of:
a pin body having a first pin end and a second pin end;
a first pin collar proximate to said first pin end; and
a second pin collar proximate to said second pin end,
wherein said flexible tensile member is positioned around said pin between said first and second pin collars and wherein said first and second pin collars align said flexible tensile member within said aperture.

5. The anchor system of claim 1 wherein said anchor fitting is substantially flush mountable to an inside surface of a vehicle.

6. The anchor system of claim 5 wherein said inside surface being selected from the group of vehicle wall and vehicle floor.

7. The anchor system of claim 5 wherein said anchor is adapted to be attached to a vehicle frame in a pocket within said inside vehicle surface so said front surface of the anchor is substantially flush with said inside vehicle surface.

8. The anchor system of claim 7 wherein said anchor is attached to a vehicle comprising a railcar.

9. The anchor system of claim 1 wherein said flexible tensile member being selected from the group consisting of a woven synthetic fiber strap, a metal band and a metal strap.

10. An anchor fitting for attachment to a vehicle comprising:
a front surface having a receiving section adapted to receive a securement connector, a clearance cavity disposed about said receiving section and a securement aperture adapted to receive an anchor pin, said anchor pin being affixed to a first end of a flexible tensile member;
adjacent said front surface, a top edge, a right edge, a bottom edge, and a left edge, which interface with a vehicle support member; and
a back contoured surface adapted to cooperate with said anchor pin, securing said flexible tensile member.

11. The anchor fitting of claim 10 wherein said receiving section and said aperture are aligned vertically.

12. The anchor fitting of claim 10 wherein said receiving section and said aperture are aligned horizontally.

13. The anchor fitting of claim 10 wherein said receiving section and said anchor section are offset vertically and horizontally.

14. The anchor fitting of claim 10 wherein said receiving section and said back contoured surface are free of edges which may cut into said flexible tensile member.

15. The anchor fitting of claim 14 wherein said anchor fitting is adapted to be attached to said vehicle support member in a pocket within an inside vehicle surface so said front surface of the anchor fitting is substantially flush with said inside vehicle surface.

16. A multipurpose anchor system for securing loads in a transport vehicle comprising:
an anchor fitting for attachment to a railcar comprising
a front surface having a receiving section adapted to receive a securement connector selected from the group consisting of a hook, a clip, a pin, a woven strap, and a metal binding, and a clearance cavity disposed about said receiving section,
a securement aperture adapted to receive an anchor pin,
adjacent said front surface, a top edge, a right edge, a bottom edge, and a left edge, which interface with a railcar support member for substantially flush mounting of said anchor fitting to an inside surface of said railcar, and
a back contoured surface adapted to cooperate with and secure said anchor pin; and
a flexible tensile member having a first end, one of said securement connector and said pin being affixed to said tensile member at said first and end in cooperation with one of said receiving section and said aperture.

17. The anchor system of claim 16 wherein said anchor is adapted to be attached to a vehicle frame in a pocket within said inside vehicle surface so said front surface of the anchor is substantially flush with said inside vehicle surface.

18. The anchor system of claim 17 wherein said inside surface being selected from the group of vehicle wall and vehicle floor.

19. The anchor system of claim 16 wherein said anchor pin is comprised of:
a pin body having a first pin end and a second pin end;
a first pin collar proximate to said first pin end; and
a second pin collar proximate to said second pin end,
wherein said flexible tensile member is positioned between said first and second pin collars and wherein said first and second pin collars align said flexible tensile member within said aperture.

20. The anchor system of claim 16 further comprising:
a first flexible tensile member having a first end, said securement connector being affixed to said first end, wherein said securement connector is in cooperation with said receiving section; and
a second flexible tensile member having a second end, said anchor pin being affixed to said second end, wherein said anchor pin is secured in cooperation with said back contoured surface.
